(19) United States
(12) Patent Application Publication
(10) Pub. No.: US 2004/0117821 A1
(43) Pub. Date: Jun. 17, 2004

(54) Method and system for media exchange network with service user interface

(76) Inventors: Jeyhan Karaoguz, Irvine, CA (US); James Bennett, Laguna Beach, CA (US)

Correspondence Address: MCANDREWS HELD & MALLOY, LTD, 500 WEST MADISON STREET, SUITE 3400, CHICAGO, IL, 60661

(21) Appl. No.: 10/675,489

(22) Filed: Sep. 30, 2003

Related U.S. Application Data
(60) Provisional application No. 60/432,472, filed on Dec. 11, 2002.
(60) Provisional application No. 60/443,894, filed on Jan. 30, 2003.
(60) Provisional application No. 60/457,179, filed on Mar. 25, 2003.
(60) Provisional application No. 60/445,759, filed on Feb. 6, 2003.

(51) Int. Cl. G06F 3/00; G06F 13/00; H04N 5/445

(52) U.S. Cl. 725/37; 725/46

(57) ABSTRACT

Certain embodiments of the invention may be found in a method and system for providing information related to a broadcast television program and may comprise generating an announcement and delivering the announcement along with the broadcast television program for display on a television screen within a home. An input may be received from a user that selects a function corresponding to the delivered announcement. In response to the received input, the function may be performed at least in part outside the home. If the received input selection accepts the function, media associated with the function may be transferred to the display on the television screen. The media may be concurrently transferred with viewing of the broadcast television program. The received input may be a code representative of the function and may be generated from, a remote control, a keyboard, a scanning device and/or an audio processing device.

### FIELD OF THE INVENTION

Certain embodiments of the invention relate to providing announcements to a user. More specifically, certain embodiments of the invention relate to a method and system for providing a media exchange network with a service user interface.

### BACKGROUND OF THE INVENTION

Today, announcements about available media and services may be accomplished via TV (television) commercials, radio commercials, magazine advertisements, advertisements on the Internet, and advertisements and announcements received through email, mail and print media. A user of a TV set, for example, may need to be watching a certain TV program at a certain time in order to see a commercial announcement about a related upcoming episode to be broadcast. Similarly, a user of a digital camera may need to go to a specific web site on the Internet in order to see whether a software upgrade is available for a digital camera or other electronic equipment.

In certain applications, announcements and advertisements are adapted to pop-up on a user's PC monitor when the user's PC is connected to the Internet. For example, some Internet service providers (ISPs) provide access software that provides banner advertisements and pop-up advertisements. Although the advertisements may cycle through a variety of advertisements, the announcements and advertisements are often distracting to the user and are not of any interest to the user.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Aspects of the invention may be found in a method and system for providing information related to a broadcast television program. The method may comprise the steps of generating an announcement and delivering the announcement along with the broadcast television program for display on a television screen within a home. An input may be received from a user that selects a function which corresponds to the delivered announcement. In response to the received input, the function may be performed at least in part outside the home. A determination may be made as to whether the received input selection accepts or rejects the function. If the received input selection accepts the function, media associated with the function may be transferred to the display on the television screen. The media may be transferred concurrently with viewing of the broadcast television program.

In accordance with an embodiment of the invention, the received input may be a code that is representative of the function. The input may be generated from, for example, a remote control, a keyboard, a scanning device and/or an audio processing device. Notwithstanding, supplemental information related to the broadcast television program may be generated in response to the received input and presented to the user via for example, the television screen. In this regard, the supplemental information may be presented to the user concurrently with the broadcast television program.

Another embodiment of the invention may provide a machine-readable storage, having stored thereon, a computer program having at least one code section for providing information related to a television broadcast. The at least one code section may be executable by a machine, thereby causing the machine to perform the steps as described above for providing information related to a television broadcast.

Aspects of the system for providing access to information related to a broadcast television program may comprise at least one processor that may be adapted to generate an announcement and deliver the announcement along with the broadcast television program for display on a television screen within a home. The processor may be a media processing system processor, a media management system processor, a computer processor, a media exchange software processor, a media peripheral processor or a combination thereof. Notwithstanding, the processor may receive an input from a user that selects a function which corresponds to the delivered announcement. In response to the received input, a function may be performed by the at least one processor at least in part outside the home. The processor may further determine whether the received input selection accepts or rejects the function. If the received input selection accepts the function, media associated with the function may be transferred to the display on the television screen. The media may be transferred concurrently with viewing of the broadcast television program.

In accordance with an embodiment of the invention, the received input may be a code that is representative of the function, which may be generated by, for example, a remote control, a keyboard, a scanning device and/or an audio processing device. Notwithstanding, supplemental information related to the broadcast television program may be generated by the processor in response to the received input and presented to the user via for example, the television screen. In this regard, the processor may cause supplemental information to be presented to the user concurrently with the broadcast television program.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a diagram illustrating an embodiment of a media exchange network providing a service user interface, in accordance with various aspects of the present invention.

FIG. 2 is a flowchart illustrating an embodiment of a method to provide a service user interface in the media exchange network of FIG. 1, in accordance with various aspects of the present invention.

FIG. 3 is a schematic block diagram of a first exemplary media exchange network in accordance with an embodiment of the present invention.

FIG. 4 is a schematic block diagram of performing personal media exchange over a second exemplary media exchange network in accordance with an embodiment of the present invention.

FIG. 5 is a schematic block diagram of performing third-party media exchange over a third exemplary media exchange network in accordance with an embodiment of the present invention.

FIG. 6 is an exemplary illustration of a TV guide channel user interface in accordance with an embodiment of the present invention.

FIG. 7 is an exemplary illustration of several instantiations of a TV guide channel user interface of FIG. 4 in accordance with an embodiment of the present invention.

FIG. 8 is an exemplary illustration of a TV guide channel user interface showing several options of a pushed media in accordance with an embodiment of the present invention.

FIG. 9A is a schematic block diagram of a media processing system (MPS) interfacing to media capture peripherals in accordance with an embodiment of the present invention.

FIG. 9B illustrates an alternative embodiment of a media processing system (MPS) in accordance with various aspects of the present invention.

FIG. 10 is a schematic block diagram of a PC and an MPS interfacing to a server on a media exchange network in accordance with an embodiment of the present invention.

FIG. 11 is a schematic block diagram of a PC interfacing to personal media capture devices and remote media storage on a media exchange network in accordance with an embodiment of the present invention.

### DETAILED DESCRIPTION OF THE INVENTION

Certain embodiments of the invention may be found in a method and system for providing information related to a broadcast television program and may comprise generating an announcement and delivering the announcement along with the broadcast television program for display on a television screen within a home. An input may be received from a user that selects a function corresponding to the delivered announcement. The received input may be a code that is representative of the function and may be generated from a remote control, a keyboard, a scanning device and/or an audio processing device. In response to the received input, the function may be performed at least in part outside of the home. If the received input selection accepts the function, media associated with the function may be transferred to the display on the television screen. The media may be concurrently transferred with viewing of the broadcast television program. In another aspect of the invention, supplemental information related to the broadcast television program may be generated in response to the received input and presented to the user via for example, the television screen. The supplemental information may be presented to the user concurrently with the broadcast television program. The supplemental information may include, but is not limited to, text, audio and/or video content.

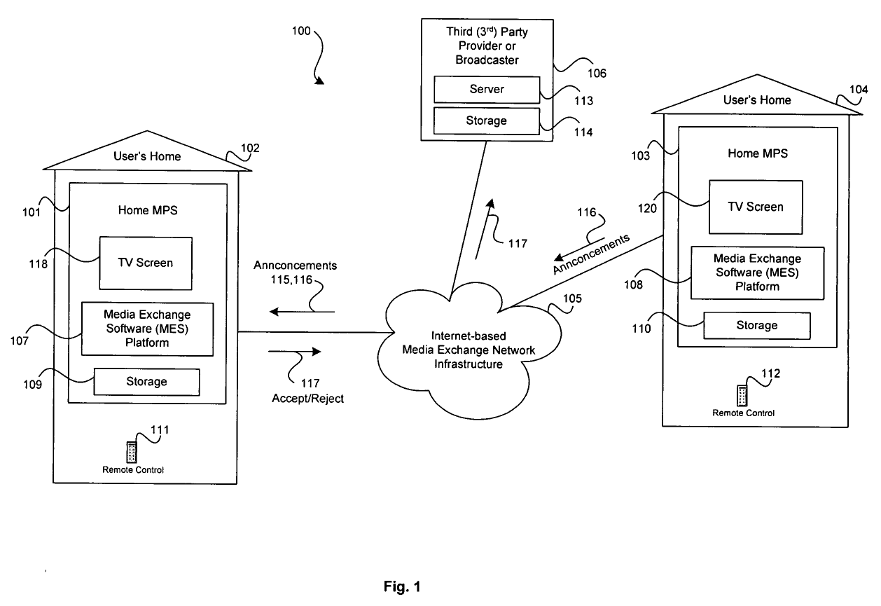

FIG. 1 is a diagram illustrating an embodiment of a system that supports media communication providing a service user interface, in accordance with various aspects of the present invention. The media exchange network 100 may also be referred to as a system that supports media communication. In any case the system that supports media communication may comprise a first location 102, a second location 104, a third (3^{rd}) party provider 106, and an Internet-based media exchange network infrastructure 105. The first location 102 may be user's home and may be referred to as a user location. The second location 104 may be friend's or family member's home. The Internet-based media exchange network infrastructure 104 provides connectivity between media processing systems 101, 103 and the third (3^{rd}) party broadcaster 103. The system that supports media communication 100 may be referred to as a media exchange network 100.

The user location or user's home 102 may include a media processing system (MPS) 101 and a remote control 111. In the exemplary embodiment of FIG. 1, since the media processing system 101 is located at the user's home, it may be referred to as a home media processing system 101. The friend's or family member's home 104 may also include a media processing system 103 and a remote control 112. In a similar manner, since the media processing system 103 is located at the friend's or family member's home, it may be referred to as a friend's or family member's media processing system 103.

Notwithstanding, the media processing systems 101 may include a media exchange software (MES) platform 107, a TV screen 118 and a storage block 109. The media processing systems 103 may also include a media exchange software platform 108, and a storage block 110. The media exchange software platforms 107, 108 may be adapted to provide certain functionality within the media processing system 101, which may include, but is not limited to, the ability to receive and/or process media content, and to process media announcements within the system that supports media communication 100. Additionally, the media exchange software platforms 107, 108 may provide the ability for a user to respond to media announcements. Accordingly, the media exchange software platforms 107, 108 may push or otherwise cause media content and announcements to be communicated on the system that supports media communication 100 via the Internet-based media exchange network infrastructure 105.

In general, a media exchange software platform may provide a user of a media processing system with the capability to control information related to media, data and/or service announcements using, for example, the remote control. For example, the media exchange software platform 105 may provide a user of the home media processing system 101 with the capability to control interaction of announcements using, for example, the remote control 111. In a somewhat similar manner, the media exchange software platform 103 may provide a user of the friend or family member's home with the capability to control interaction of announcements using, for example, the remote control 112. In either case, the user may be adapted to utilize a user input to control a service announcement. For example, the remote control 111 may be adapted to receive a user input to control a service announcement functionality of the media processing system 101.

The remote control 108 may communicate in a wireless manner with the MPS 101 via infrared or RF signals, in accordance with various embodiments of the invention. Similarly, the remote control 112 may be adapted to receive a user input to control a service announcement functionality of the media processing system 103. In this regard, the remote control 108 may communicate in a wireless manner with the MPS 103 via infrared or RF signals, in accordance with various embodiments of the invention.

Although the remote control 108 may be utilized to control at least some of the service announcement functionality of the media processing systems 101, and 103, the invention is not so limited. Accordingly, the user may utilize other devices that may function as I/O devices and/or navigational tools to control the service announcement functionality of the media processing systems 101, 103. For example, a mouse, a touch-screen TV display, and/or a keyboard may be utilized to control the synchronized functionality of the media processing systems 101, 103. In accordance with another aspect of the invention, a special code reading device may be utilized to scan, read and/or interpret various service announcement functionality codes that may be displayed on the TV screen 118, for example. The special code reading device may also have the capability to scan service announcement functionality that may be found in print media including, but not limited to, magazines, newspapers, books and charts.

A media announcement may comprise an announcement about a certain media content that has become available on the media exchange network or system that supports media communication 100. For example, the newly available media content may comprise a movie, a broadcast TV program, an advertisement, a commercial, a catalog and/or other print media. A service announcement may comprise an announcement about a certain service that has become available on the media exchange network or system that supports media communication 100. For example, the newly available service may comprise providing a software upgrade to a user's digital peripheral, providing diagnosis of a problem with a user's PC and/or providing alerts to a user about recently discovered problems with an appliance.

A media processing system may also comprise a set-top-box (STB), a PC, and/or a television with a media management system (MMS). A media management system may also be referred to as a media exchange software (MES) platform. Notwithstanding, a media management system may include a software platform operating on at least one processor that may provide certain functionality including user interface functionality, distributed storage functionality, networking functionality, and automatic control and monitoring of media peripheral devices. For example, a media management system may provide automatic control of media peripheral devices, automatic status monitoring of media peripheral devices, and inter-home media processing system routing selection. A media processing system may also be referred to as a media-box and/or an M-box. Any personal computer may indirectly access and/or control any media peripheral device in instances where the personal computer may include a media management system. Such access and/or control may be accomplished through various communication pathways via the media processing system or outside of the media processing system. A media processing system may also have the capability to automatically access and control any media peripheral device without user interaction and/or with user intervention. A personal computer (PC) may include media exchange software running on or being executed by the personal computer and may be referred to as a media processing system. The media processing system may also include a speech recognition engine that may be adapted to receive input speech and utilize the input speech control various functions of the media processing system.

Each of the elements or components of the network for communicating media or media exchange network may be identified by a network protocol address or other identifier which may include, but is not limited to, an Internet protocol (IP) address, a media access control (MAC) address and an electronic serial number (ESN). Examples of elements or components that may be identified by such addresses or identifiers may include media processing systems, media management systems, personal computers, media or content providers, media exchange software platforms and media peripherals.

The Internet-based media exchange network infrastructure or communication infrastructure 105 may include cable infrastructure, xDSL infrastructure, satellite network infrastructure, Internet infrastructure, intranet infrastructure or other similar access and/or transport infrastructure. In this regard, the Internet-based media exchange network infrastructure 105 may provide access and/or transport functionality that may facilitate the exchange of media between, for example, the user's home 102, second location 104 and the third (3rd) party broadcaster or provider 106. The intranet infrastructure which may be part of the Internet-based media exchange network infrastructure may also be adapted to providing wide area network (WAN) capability.

The third (3^{rd}) party media provider or broadcaster 106 may supply third (3^{rd}) party media content to user locations such as the user's home 102 and/or friend or family member's home 104 via the Internet-based media exchange network infrastructure 105. The supplied third (3^{rd}) party media content may include announcements 115. The third (3^{rd}) party media provider or broadcaster 106 may include a server 113 and a storage block 114.

The server 113 may be, for example, a file-based server and may be implemented as part of or an adjunct to a personal computer (PC) and/or a mainframe computer system. Notwithstanding, the server 113 may have the capability to push broadcast media content that is stored in the storage block 114 to the media processing systems 101, 103 via the Internet-based media exchange network infrastructure 105. In accordance with an aspect of the invention, the server 113 may also be configured to provide media and service announcement 115 functionality to user's of the media exchange network or system that supports media communication 100.

The storage block 114 may be utilized to store media content provided by the (3^{rd}) party media provider or broadcaster 106. The storage block 114 may include, but is not limited to, a database, a CD tower, a jukebox, a magnetic disk, an optical disk, a magneto-optical disk, a solid state memory device, a tape device, a media peripheral, a server, a media processing system and a computer having various memory and/or storage devices.

The storage block 109 of media processing system 101 may be utilized to store media content such as media content associated with service announcement functionality. Similarly, the media processing system 103 may also comprise a storage area 110 that may be utilized to store media content associated to service announcement functionality, for example. The media processing system 103 may be adapted to communicate media content located in its associated storage block 110 to users of the media exchange network 100 such as a user located at the first location 102 via the Internet-based media exchange network infrastructure 105. In a somewhat similar manner, the media processing system 101 may be adapted to communicate media content located in its associated storage block 109 to users of the media exchange network 100 such as a user located at the first location 102 via the Internet-based media exchange network infrastructure 105. In this case, media content in the storage 110 may be transferred to the media processing system 101 and media content in the storage 109 may be transferred to the media processing system 103.

Each of the media processing systems 101, 103 may have the capability to receive the media from the third (3^{rd}) party provider 106, in accordance with various embodiments of the invention. The TV screen 106 of the media processing system 101 may provide a user with the capability to receive and view media content associated with service announcement functionality. Accordingly, a notification associated with an announcement function may be received from the third (3^{rd}) party broadcaster 103 and may be displayed on the TV screen 118 of the media processing system 101. The notification may be automatically displayed or it may be displayed based on user interaction. For example, the user interaction may include the pushing of a button on the remote control 118 by a user of the media processing system 101. In this regard, the user may choose when to view the service announcement notification and may even decide what types of service announcement notification should be received and when they should be received.

In accordance with another embodiment of the invention, the home media processing system 101 may be adapted to receive the announcements 115 and 116 and accept or reject the announcements 115 and 116. In this regard, a service announcement 115 received from the third (3^{rd}) party provider 106 may be received by a user of the home media processing system 101. This may cause an announcement pop-up, query-style message or banner to be displayed on the television screen 118 of the media processing system 101. The user of the home media processing system 101 may view, among other things, media content associated with the service announcement 115 from the third party provider 106. The user of the home media processing system 101 may interact with the service announcement by utilizing the remote control 111 to control the service announcement functionality of the home media processing system 101. Accordingly, interaction with the service announcement 115 may result in the user causing the home media processing system 101 to present media associated with the announcement functionality to be displayed on the television screen 118.

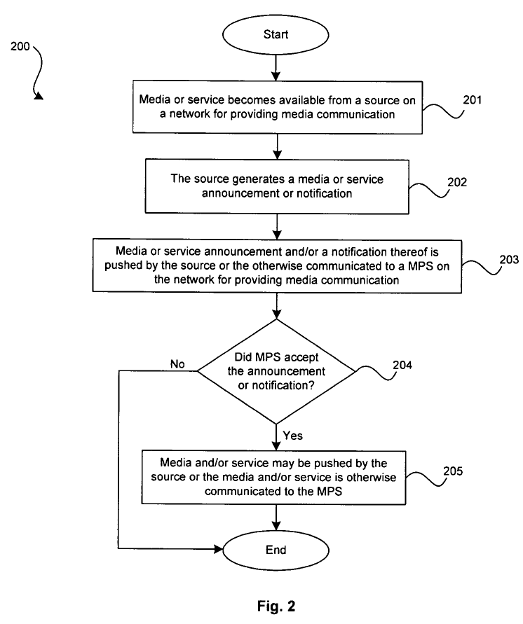

FIG. 2 is a flowchart illustrating an embodiment of a method 200 that provides a service user interface in the media exchange network or network for communicating media 100 of FIG. 1, in accordance with various aspects of the present invention. Referring to FIG. 2, in step 201, a media content or a service becomes available from a source on a network providing media communication. In step 202, the source generates a media or service announcement or notification. In step 203, a media or service announcement or a notification thereof is pushed by the source or otherwise communicated to a media processing system on the network providing media communication. In step 204, a determination is made as to whether the media processing system accepted the service announcement or notification. If the media processing system accepted the service announcement or notification, then in step 205, media and/or service corresponding to the announcement and/or notification may be pushed by the sources or otherwise communicated to the media processing system. If the media processing system rejects the service announcement or notification, then the exemplary steps may end, thereby bypassing step 205.

As an alternative, a source such as a content provider may be pre-authorized to push media and services to a media processing system on the media exchange network. As a result, step 204 may be bypassed and the announcement and/or notification in step 203 may state that the push is going to occur. In any case, although not shown in FIG. 2, the source may be the third (3^{rd}) party provider or broadcaster 106.

In accordance with various embodiments of the invention, an announcement or notification may be associated with a media content currently being consumed by a user of the network for communicating media 100, or may be independent of a media content currently being consumed by the user. For example, a media or service announcement may be pushed to a user of the network for communicating media 100 based on a profile of the user. A user may establish a profile or a default profile may be assigned to a user. The default profile may be assigned to a user upon initial service provisioning and the user may edit the default profile at any time. Announcements may also be provided to a user of the media exchange network 100 by a third (3^{rd}) party provider 106 or by a friend or family member 104 in accordance with various aspects of the present invention.

Media content that is pushed to a media processing system on a media exchange network as the result of an announcement or notification may be immediately consumed by the user of the media processing system or may be scheduled to be subsequently consumed. In any case, the pushed media or service may be pushed to a storage area of the media processing system, a channel view of the media processing system, or a media view of the media processing system, in accordance with various aspects of the present invention. For example, with reference to FIG. 1, media content from the third (3^{rd}) party provider or broadcaster may be pushed or otherwise communicated to the media processing system 102 at the first location 102 via the Internet-based media exchange network infrastructure 105.

A channel view of a media processing system may comprise a table of media channels along with corresponding scheduled media content, in accordance with an embodiment of the present invention. A media view of a media processing system may comprise a table of media content categories versus media content, in accordance with an embodiment of the present invention. Both the channel view and the media view may be viewed by a user on a television screen of a media processing system. U.S. application Ser. No. ______ (Attorney Docket No. 14276US02) filed Sep. 30, 2003 discloses a method and system for media processing providing access to a channel guide, aspects of which illustrate exemplary media and device views, the contents of which are incorporated herein by reference in its entirety. U.S. application Ser. No. ______ (Attorney Docket No. 14306US02) filed Sep. 30, 2003 discloses a method and system for media exchange network functionality synchronized with media broadcasting, which provides, among other things, access to information related to a broadcast television program and is incorporated herein by reference in its entirety.

In an exemplary embodiment of the invention, a user of the home media processing system 101 may be watching a first movie on the TV screen 118 of the home media processing system 101. The first movie may be provided by the third (3^{rd}) party provider 106. When the credits at the end of the first movie are scrolling, the third (3^{rd}) party provider may send a media announcement 115 to the home media processing system 101. The media announcement 115 may pop up on the TV screen 118 and state, for example, “If you liked the first movie, you may also like a second movie”. The user may accept the announcement by utilizing the remote control 111 to sending an accept message 117 to the 3^{rd} party provider 106. The third (3^{rd}) party provider 106 may then push the second movie to the home media processing system 101 and store it in the media view, for example.

As another example, a friend located at friend's house 104 may use the remote control 112 to push or otherwise cause a media announcement 116 to be communicated from the media processing system 103 to the home media processing system 101 at the first location 102. The media announcement may indicate that a digital video of the friend's recent vacation is available. The user of the home media processing system 101 may utilize the remote control 111 to accept the announcement 116 and to express a desire to view the vacation video at 9:00 PM. on Saturday night. Accordingly, an accept message 117 being pushed to the media processing system 103. In response to the accept message 117, the media processing 103 may then push the digital video of the friend's vacation to the channel view of the home media processing system 101, scheduled to be viewed at 9:00 p.m. on Saturday night.

Other examples may include a third (3^{rd}) party vendor sending an announcement about a software upgrade for a user's personal digital assistant (PDA), a third (3^{rd}) party provider sending an announcement indicating that an interview with the star of the television program that the user just watched is available, a third (3^{rd}) party provider sending an announcement to a user (based on a user profile) that a modeling program will be available at 8:00 p.m. on Wednesday night.

A major challenge is to be able to transfer and share many different types of digital media, data, and services between one device/location and another with ease while being able to index, manage, and store the digital media and data.

For example, it is desirable to be able to distribute and store many types of digital media in a PC and/or television environment in a user-friendly manner without requiring many different types of software applications and/or unique and dedicated interfaces. Any networking issues or other technical issues should be transparent to the users. It is also desirable to take advantage of existing hardware infrastructure, as much as possible, when providing such capability.

In an embodiment of the present invention, a media exchange network is provided that enables many types of digital media, data, and/or services to be stored, indexed, viewed, searched for, pushed from one user to another, and requested by users, using a media guide user interface. The media exchange network also allows a user to construct personal media channels that comprise his personal digital media (e.g., captured digital pictures, digital video, digital audio, etc.), request that third-party media channels be constructed from third-party digital media, and access the media channels pushed to him by other users on the media exchange network.

PC's may be used but are not required to interface to the media exchange network for the purpose of exchanging digital media, data, and services. Instead, set-top-boxes or integrated MPS's (media processing systems) may be used with the media exchange network to perform all of the previously described media exchange functions using a remote control with a television screen.

Current set-top-boxes may be software enhanced to create a MPS that provides full media exchange network interfacing and functionality via a TV screen with a TV guide look-and-feel. PC's may be software enhanced as well and provide the same TV guide look-and-feel. Therefore, the media exchange network supports both PC's and MPS's in a similar manner. Alternatively, a fully integrated MPS may be designed from the ground up, having full MPS capability.

In the case of an MPS configuration, the user takes advantage of his remote control and TV screen to use the media exchange network. In the case of a PC configuration, the user takes advantage of his keyboard and/or mouse to use the media exchange network.

An MPS or enhanced PC is effectively a storage and distribution platform for the exchange of personal and third party digital media, data, and services as well as for bringing the conventional television channels to a user's home. An MPS and/or PC connects to the media exchange network via an existing communication infrastructure which may include cable, DSL, satellite, etc. The connection to the communication infrastructure may be hard-wired or wireless.

The media exchange network allows users to effectively become their own broadcasters from their own homes by creating their own media channels and pushing those media channels to other authorized users on the media exchange network, such as friends and family members.

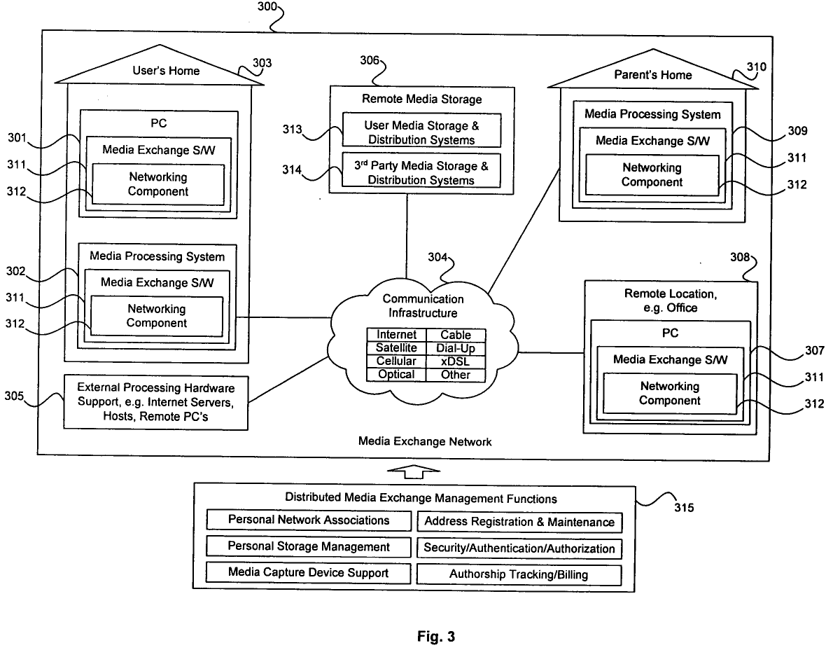

FIG. 3 comprises a media exchange network 300 for exchanging and sharing digital media, data, and services in accordance with an embodiment of the present invention. The media exchange network 300 is a secure, closed network environment that is only accessible to pre-defined users and service providers. The media exchange network of FIG. 3 comprises a first PC 301 and a first media processing system (MPS) 302 at a user's home 303, a communication infrastructure 304, external processing hardware support 305, remote media storage 306, a second PC 307 at a remote location 308 such as an office, and a second MPS 309 at a parent's home 310.

The PC's 301 and 307 and the MPS's 302 and 309 each include a media exchange software (MES) platform 311 and a networking component 312 for connectivity. The MES platform 311 provides multiple capabilities including media “push” capability, media “access” capability, media channel construction/selection, image sequence selection, text and voice overlay, channel and program naming, inter-home routing selection, authorship and media rights management, shared inter-home media experience, billing service, and an integrated media guide interface providing a TV channel guide look-and-feel.

The external processing hardware support 305 comprises at least one server such as a centralized internet server, a peer-to-peer server, or cable head end. The server may alternatively be distributed over various hosts or remote PC's. The MES platform 311 may also reside on the external processing hardware support server 305. The remote media storage 306 may comprise user media storage and distribution systems 313 and/or third party media storage and distribution systems 314.

The communication infrastructure 304 may comprise at least one of internet infrastructure, satellite infrastructure, cable infrastructure, dial-up infrastructure, cellular infrastructure, XDSL infrastructure, optical infrastructure, or some other infrastructure. The communication infrastructure 304 links the user's home 303, parent's home 310, remote media storage 306, and remote location office 308 to each other (i.e., the communication infrastructure 304 links all users and service providers of the media exchange network 300).

The various functions 315 of the media exchange network 300 comprise generating personal network associations, personal storage management, media capture device support, security/authentication/authorization support, authorship tracking and billing and address registration and maintenance. These media exchange management functions 315 may be distributed over various parts of the media exchange network 300. For example, the personal network associations and personal storage management functions may be integrated in the PC 301 at the user's home 303.

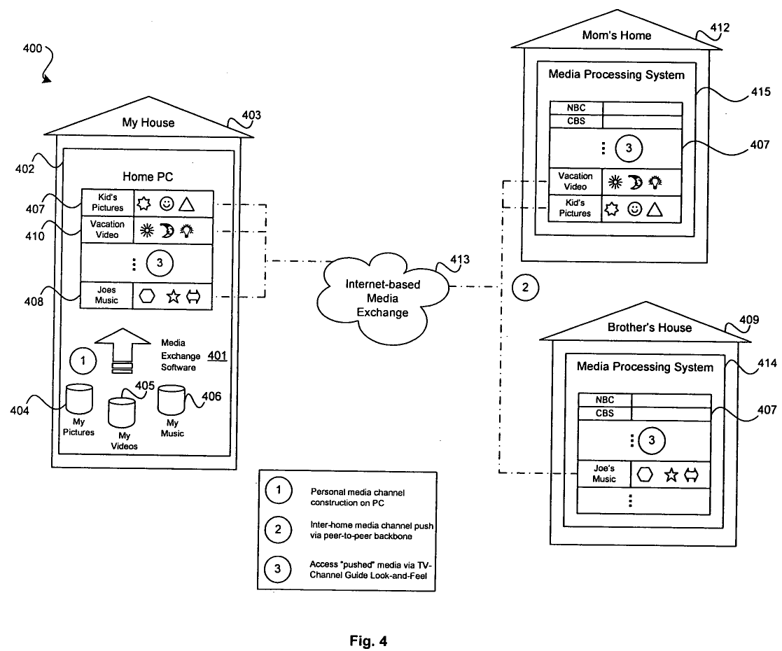

FIG. 4 illustrates an example of personal media exchange over a media exchange network 400 in accordance with an embodiment of the present invention. In step 1, the media exchange software (MES) platform 401 is used to construct personal media channels on a PC 402 by a user at “my house” 403. For example, with various media stored on the PC 402 such as digital pictures 404, videos 405, and music 406, the MES platform 401 allows the digital media to be organized by a user into several channels having a media guide user interface 407 on the PC 402.

In step 2, the user at “my house” 403 pushes a media channel 408 (e.g., “Joe's Music”) to “brother's house” 409 and pushes two media channels 410 and 411 (e.g., “Vacation Video” and “Kid's Pictures”) to “Mom's house” 412 via a peer-to-peer server 413 over the internet-based media exchange network 400. “Brother's house” 409 includes a first MPS 414 connected to the media exchange network 400. “Mom's house” 412 includes a second MPS 415 connected to the media exchange network 400. The MPS's 414 and 415 also provide a media guide user interface 407.

In step 3, brother and/or Mom access the pushed media channels via their respective media processing systems (MPS's) 414 and 415 using their respective MPS TV screens and remote controls.

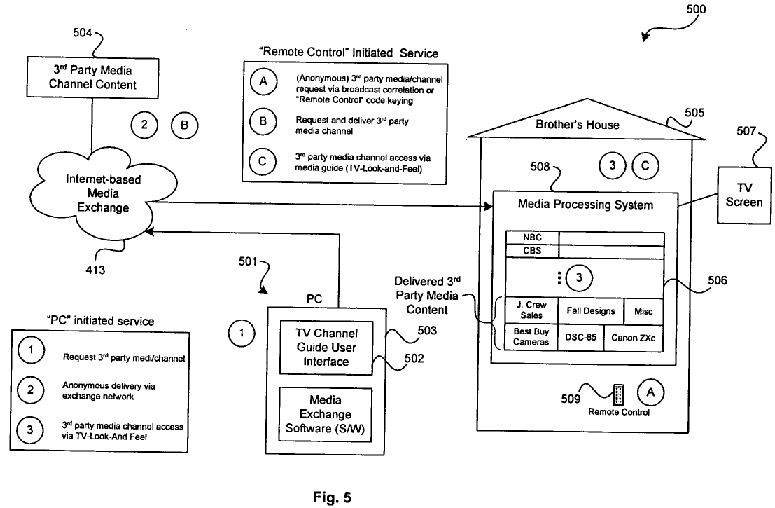

FIG. 5 illustrates an example of third-party media exchange over a media exchange network 500 in accordance with an embodiment of the present invention. In step 1, a PC-initiated third-party request is made by a first party 501 via an internet-based media exchange network 500 using a media guide user interface 502 on a PC 503. In step 2, an anonymous delivery of the requested third-party channel 504 is made to a second party 505 via the internet-based media exchange network 500. In step 3, the second party 505 accesses the third-party channel 504 using a media guide user interface 506 on a TV screen 507 that is integrated into an MPS 508.

Similarly, in step A, an MPS-initiated third-party request is made by a second party 505 via an internet-based media exchange network 500 using a media guide user interface 506 on a TV screen 507 using a remote control 509. The second party 505 may key in a code, using his remote control 509, that is correlated to a commercial or some other third party broadcast media. In step B, an anonymous delivery of the requested third-party channel 504 is made to a first party 501 via the internet-based media exchange network 500. In step C, the first party 501 accesses the third-party channel 504 using a media guide user interface 502 on a PC 503.

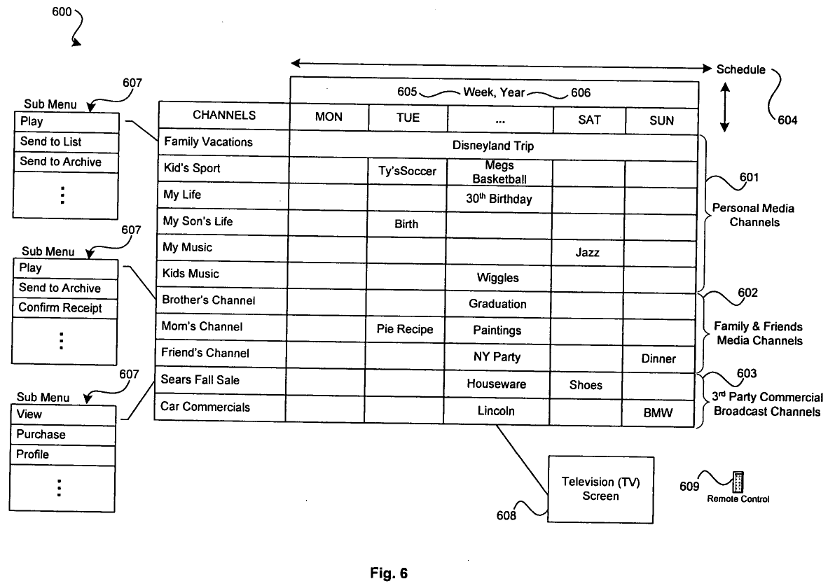

FIG. 6 illustrates a media guide user interface 600 in accordance with an embodiment of the present invention. The media guide user interface 600 may be displayed on a TV screen 608 and controlled by a remote control device 609. Also, the media guide user interface 600 may be displayed on a PC monitor and controlled by a keyboard or mouse.

The media guide user interface 600 may be configured not only for conventional TV channels but also for personal media channels 601 that are constructed by a user of a media exchange network, friend's and family's media channels 602 constructed by friends and family, and third party channels 603 that are constructed by third parties either upon request by a user of a media exchange network or based on a profile of a user.

The personal media channels 601 may include, for example, a “family vacations channel”, a “kid's sports channel”, a “my life channel”, a “son's life channel”, a “my music channel”, and a “kid's music channel”. The friends and family media channels 602 may include, for example, a “brother's channel”, a “Mom's channel”, and a “friend's channel”. The third party media channels 603 may include, for example, a “Sears Fall sale channel” and a “car commercials channel”.

Each media channel may correspond to a schedule 604 showing, for example, a week 605 and a year 606. For example, under the “kid's sports channel”, Ty's soccer game could be scheduled to be viewed on Tuesday of the current week 605 and current year 606. For each media channel, a sub-menu 607 allows for selection of certain control and access functions such as “play”, “send to list”, “send to archive”, “confirm receipt”, “view”, “purchase”, and “profile”.

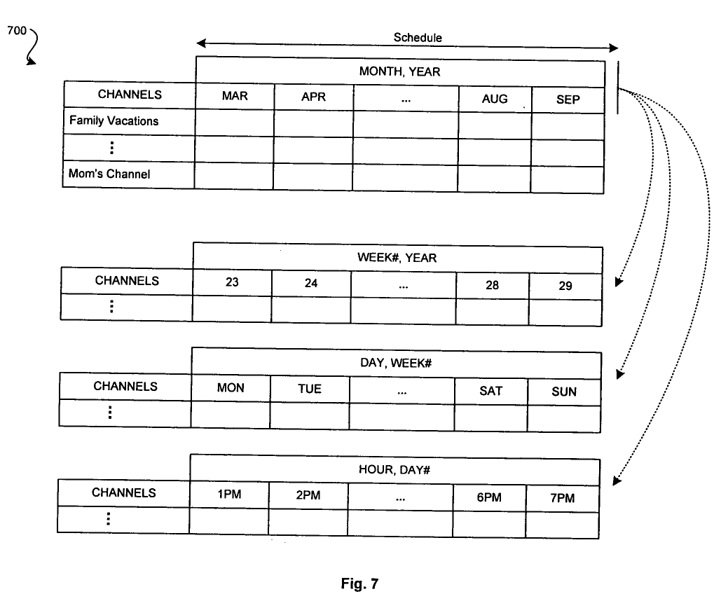

FIG. 7 illustrates possible multiple instantiations of a media guide user interface 700 in accordance with an embodiment of the present invention. The media guide user interface 700 may be viewed with a schedule having formats of, for example, “month, year”, “week#, year”, “day, week#”, or “hour, day”.

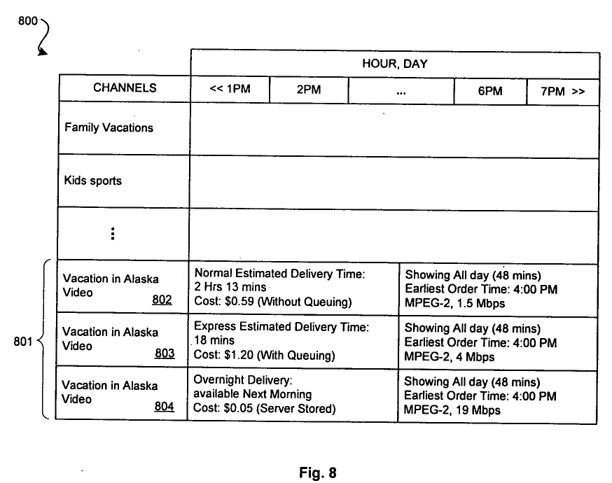

Referring to FIG. 8, a user of a media exchange network may push a media channel (e.g., “Vacation in Alaska Video”) to a friend who is on the same media exchange network. The media guide user interface 800 may give the friend several options 801 for how to accept and download the pushed media in accordance with an embodiment of the present invention.

For example, a first, most expensive option 803 may be “Express Delivery” which would deliver the pushed media to the friend in 18 minutes using queuing and cost $1.20, for example. The pushed media may be stored in a file in an MPEG 2 format that was recorded at a rate of 4 Mbps, for example. Queuing comprises buffering and delivering a previous part of the media and then buffering and delivering a next part of the media. For example, a first six minutes of the “Vacation in Alaska Video” may be buffered and delivered first, then a second six minutes may be buffered and delivered next, and so on until the entire media is delivered.

A second, less expensive option 802 may be “Normal Delivery” which would deliver the pushed media in 2 hours and 13 minutes without queuing and cost $0.59, for example. The pushed media may be stored in a file in an MPEG 2 format that was recorded at a rate of 1.5 Mbps, for example.

A third, least expensive option 804 may be “Overnight Delivery” which would deliver the pushed media by the next morning and cost only $0.05, for example. The pushed media may be stored in a file in an MPEG 2 format that was recorded at a rate of 19 Mbps and stored on a server, for example.

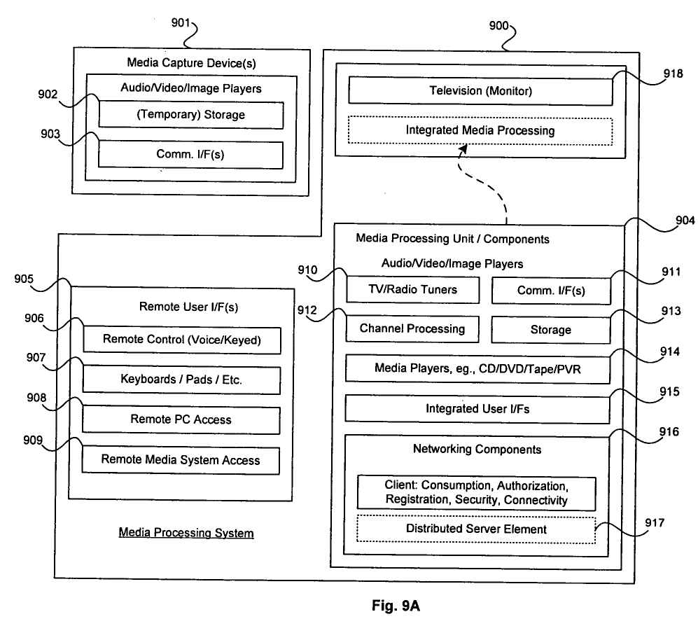

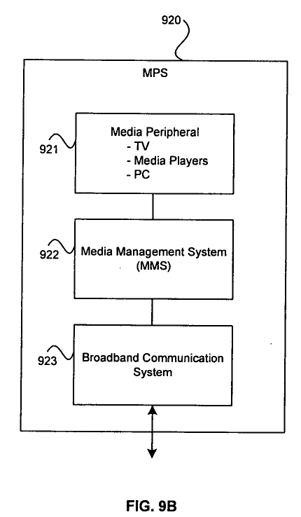

FIG. 9A illustrates the detailed elements of a media processing system (MPS) 900 and media capture devices 901 in accordance with an embodiment of the present invention. The media capture devices 901 may comprise audio, video, and image players, such as digital cameras, digital camcorders, and MP3 players, that each include a temporary storage area 902 and a communication interface 903 such as, for example, a USB interface or a wireless interface. The media capture devices 901 have the capability to interface to an MPS and a PC.

The MPS 900 comprises a media processing unit (MPU) 904, remote user interface(s) 905, and a TV screen 918 to provide integrated media processing capability and indirect user interface capability. The remote user interfaces 905 may comprise a voice or keyed remote control 906, keyboards and pads 907, a remote PC access interface 908, and a remote media system access interface 909 (i.e., providing access from another MPS).

The media processing unit (MPU) 904 comprises TV and radio tuners 910 for image and audio consumption, communications interfaces 911, channel processing 912 (creating, storing, indexing, viewing), storage 913, media players 914 (CD, DVD, Tape, PVR, MP3), an integrated user interface 915 (to provide a TV channel guide look-and-feel), networking components 916 to provide client functions such as consumption (billing), authorization (e.g., using digital certificates and digital ID's), registration, security, and connectivity. In an alternative embodiment of the present invention, the networking components 916 may include a distributed server element 917 that is part of a distributed server.

FIG. 9B illustrates an alternative embodiment of a media processing system (MPS) 920 in accordance with various aspects of the present invention. The MPS 920 is essentially an enhanced set-top-box for viewing and interacting with various user interfaces, media, data, and services that are available on the media exchange network using, for example, a remote control. The MPS 920 comprises a media peripheral 921, a MMS (media management system) 922, and a broadband communication interface 923.

The media peripheral 921 may include a TV (television), a PC (personal computer), and media players (e.g., a CD player, a DVD player, a tape player, and a MP3 player) for video, image, and audio consumption of broadcast and/or personal channels. The broadband communication interface 923 may include internal modems (e.g., a cable modem or DSL modem) or other interface devices in order to communicate with, for example, a cable or satellite headend.

The MMS 922 includes a software platform to provide functionality including media “push” capability, media “access” capability, media channel construction/selection, image sequence selection, text and voice overlay, channel and program naming, inter-home routing selection, authorship and media rights management, shared inter-home media experience, billing service, and a media guide user interface providing an integrated TV channel guide look-and-feel.

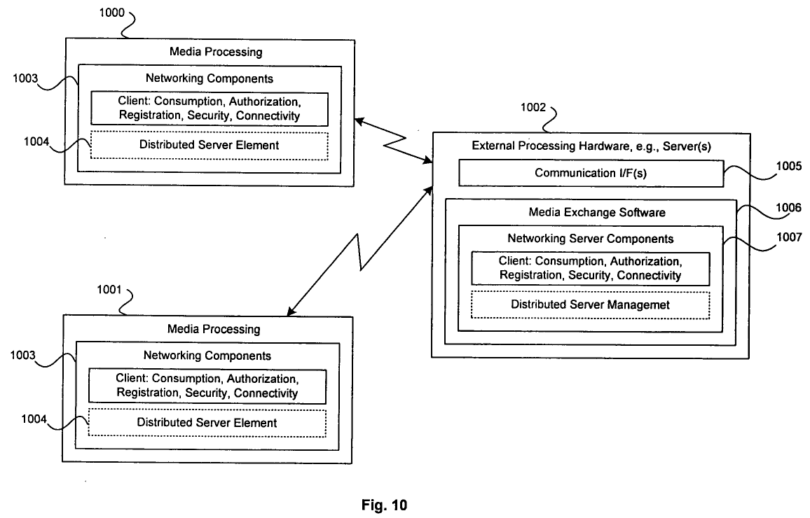

FIG. 10 illustrates connectivity between a PC 1000, an MPS 1001, and external processing hardware 1002 (e.g., a server) in accordance with an embodiment of the present invention. The PC 1000 and MPS 1001 include networking components 1003 to provide client functions such as consumption (billing), authorization, registration, security, and connectivity. Alternatively, the PC 1000 and MPS 1001 may include a distributed server element 1004 that is part of a distributed server.

The PC 1000 and MPS 1001 connect to the external processing hardware 1002 via wired or wireless connections. The external processing hardware 1002 comprises a distributed server or peer-to-peer server. The external processing hardware 1002 also comprises communication interfaces 1005 (e.g., cable interfaces, optical interfaces, etc.) and a media exchange software (MES) platform 1006. The MES platform 1006 in the external processing hardware 1002 allows for communication with the PC 1000 and MPS 1001 which may also use the same MES platform 1006. The external processing hardware 1002 also includes networking server components 1007 to provide the similar client functions such as consumption (billing), authorization, registration, security, and connectivity at the server side.

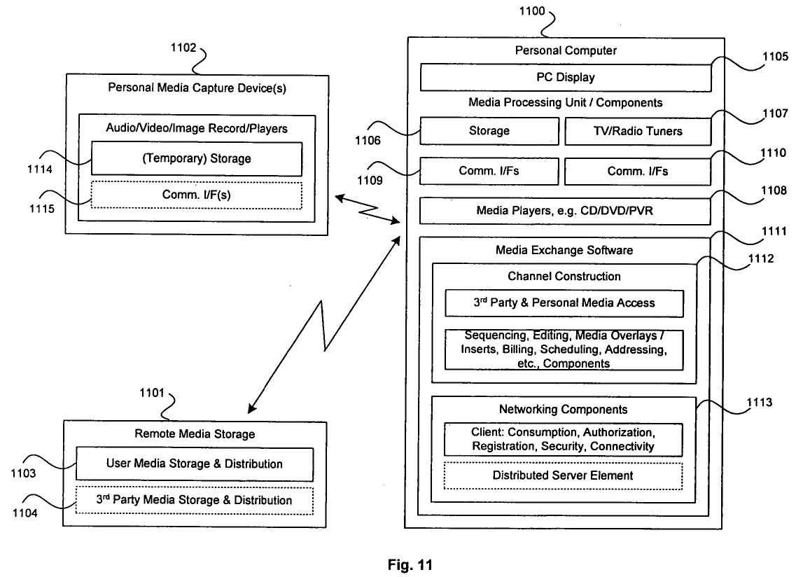

FIG. 11 illustrates connectivity between a PC 1100, remote media storage 1101, and personal media capture devices 1102 when the PC 1100 is used as the primary distributor of digital media such as in the case of PC-to-PC operation, in accordance with an embodiment of the present invention. The personal media capture devices 1102 and remote media storage 1101 connect to the PC 1100 via a wireless or wired connection. The remote media storage 1101 provides user media storage and distribution 1103 as well as third party media storage and distribution 1104. The personal media capture devices 1102 provide temporary storage 1114 and communication interfaces 1115.

Viewing is done using a PC monitor 1105 instead of a television screen. The PC 1100 may include storage 1106, TV/radio tuners 1107 for media consumption, media players 1108, and communication interfaces 1109 and user interfaces 1110 similar to those for the MPS of FIG. 9A. The PC 1100 includes a media exchange software (MES) platform 1111 that provides channel construction capability 1112 and networking capability 1113. The channel construction capability 1112 allows third party and personal media access, sequencing, editing, media overlays and inserts, billing, scheduling, and addressing.

Aspects of the system for providing access to information related to a broadcast television program may also comprise at least one processor that may be adapted to generate an announcement and deliver the announcement along with the broadcast television program for display on a television screen within a home. The processor may be a media processing system processor, a media management system processor, a computer processor, a media exchange software processor, a media peripheral processor or a combination thereof.

The processor may receive an input from a user that selects a function which corresponds to the delivered announcement. In response to the received input, a function may be performed by the at least one processor at least in part outside the home. The processor may further determine whether the received input selection accepts or rejects the function. If the received input selection accepts the function, media associated with the function may be transferred to the display on the television screen. The media may be transferred concurrently with viewing of the broadcast television program.

In accordance with an embodiment of the invention, the received input may be a code that may be representative of the function. Accordingly, the input may be generated from, for example, a remote control, a keyboard, a scanning device and/or an audio processing device. Notwithstanding, supplemental information related to the broadcast television program may also be generated by the processor in response to the received input and presented to the user via for example, the television screen. In this regard, the processor may cause supplemental information to be presented to the user concurrently with the broadcast television program.

Accordingly, the present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for providing information related to a broadcast television program, the method comprising:
generating an announcement;
delivering said announcement along with the broadcast television program for display on a television screen within a home; and
receiving an input from a user that selects a function which corresponds to said delivered announcement.

2. The method according to claim 1, further comprising in response to said received input, performing said function at least in part outside said home.

3. The method according to claim 1, further comprising determining whether said received input selection one of accepts and selects said function.

4. The method according to claim 3, further comprising if said received input selection accepts said function, transferring media associated with said function to said display on said television screen.

5. The method according to claim 4, further comprising transferring said media concurrently with viewing of the broadcast television program.

6. The method according to claim 1, wherein said input is a code representative of said function.

7. The method according to claim 1, wherein said input is generated from at least one of a remote control, a keyboard, a scanning device and an audio processing device.

8. The method according to claim 1, further comprising generating supplemental information related to the broadcast television program in response to said received input.

9. The method according to claim 8, further comprising presenting said supplemental information to said user.

10. The method according to claim 8, further comprising presenting said supplemental information to said user concurrently with the broadcast television program.

11. A machine-readable storage having stored thereon, a computer program having at least one code section for providing information related to a broadcast television program, the at least one code section being executable by a machine for causing the machine to perform steps comprising:
generating an announcement;
delivering said announcement along with the broadcast television program for display on a television screen within a home; and
receiving an input from a user that selects a function which corresponds to said delivered announcement.

12. The machine-readable storage according to claim 11, further comprising code for performing said function at least in part outside said home in response to said received input.

13. The machine-readable storage according to claim 11, further comprising code for determining whether said received input selection one of accepts and selects said function.

14. The machine-readable storage according to claim 13, further comprising code for transferring media associated with said function to said display on said television screen if said received input selection accepts said function.

15. The machine-readable storage according to claim 14, further comprising code for transferring said media concurrently with viewing of the broadcast television program.

16. The machine-readable storage according to claim 11, wherein said input is representative of said function.

17. The machine-readable storage according to claim 11, wherein said input is generated from at least one of a remote control, a keyboard, a scanning device and an audio processing device.

18. The machine-readable storage according to claim 11, further comprising code for generating supplemental information related to the broadcast television program in response to said received input.

19. The machine-readable storage according to claim 18, further comprising code that causes said supplemental information to be presented to said user.

20. The machine-readable storage according to claim 18, further comprising code for presenting said supplemental information to said user concurrently with the broadcast television program.

21. A system for providing information related to a broadcast television program, the system comprising:
at least one processor that generates an announcement;
said at least one processor that delivers said announcement along with the broadcast television program for display on a television screen within a home; and
said at least one processor that receives an input from a user that selects a function which corresponds to said delivered announcement.

22. The system according to claim 21, wherein said at least one processor performs said function at least in part outside said home in response to said received input.

23. The system according to claim 21, wherein said at least one processor determines whether said received input selection one of accepts and selects said function.

24. The system according to claim 23, wherein said at least one processor transfers media associated with said function to said display on said television screen if said received input selection accepts said function.

25. The system according to claim 24, wherein said at least one processor transfers said media concurrently with viewing of the broadcast television program.

26. The system according to claim 21, wherein said input is a code representative of said function.

27. The system according to claim 21, wherein said input is generated from at least one of a remote control, a keyboard, a scanning device and an audio processing device.

28. The system according to claim 21, wherein said at least one processor generates supplemental information related to the broadcast television program in response to said received input.

29. The system according to claim 28, wherein said at least one processor presents said supplemental information to said user.

30. The system according to claim 28, said at least one processor presents said supplemental information to said user concurrently with the broadcast television program.

31. The system according to claim 21, wherein said at least one processor is at least one of a media processing system processor, a media management system processor, a computer processor, media exchange software processor and a media peripheral processor.
